(19) United States
(12) Patent Application Publication
(10) Pub. No.: US 2008/0260023 A1
(43) Pub. Date: Oct. 23, 2008

(54) Digital video encoding and decoding with refernecing frame buffer compression

(76) Inventor: Chih-Ta Star Sung, Glonn (DE)

Correspondence Address: Chih-Ta Star Sung, Rm. 308, Bld. 52, No. 195, Sec. 4, Chung Hsin Rd., Juhdong, 310, TW

(21) Appl. No.: 11/787,675

(22) Filed: Apr. 18, 2007

(51) Int. Cl. H04N 7/12

(52) U.S. Cl. 375/240.03; 375/240.16; 375/240.23; 375/E07.104; 375/E07.139; 375/E07.144

(57) ABSTRACT

The digital video encoder or video decoder with referencing frame image compression and decompression mechanism allows a smaller on-chip referencing frame storage device and efficient off-chip referencing frame random access. In using the off-chip frame buffer, a predetermined amount of line buffer temporarily saves the compressed pixels and reconstructs the needed macro-block pixels according to the motion vector for motion compensation in video decoder and reconstructs the searching range pixels for motion estimation in video encoder.

### BACKGROUND OF THE INVENTION

1. Field of Invention

The present invention relates to digital video compression and decompression with referencing frame buffer compression. And, more specifically to an efficient video bit stream compression/decompression method for an SoC, System-on-Chip design which sharply reduces the semiconductor die area and cost.

2. Description of Related Art

ISO and ITU have separately or jointly developed and defined some digital video compression standards including MPEG-1, MPEG-2, MPEG-4, MPEG-7, H.261, H.263 and H.264. The success of development of the video compression standards fuels wide applications which include video telephony, surveillance system, DVD, and digital TV. The advantage of digital image and video compression techniques significantly saves the storage space and transmission time without sacrificing much of the image quality.

Most ISO and ITU motion video compression standards adopt Y, U/Cb and V/Cr as the pixel elements, which are derived from the original R (Red), G (Green), and B (Blue) color components. The Y stands for the degree of “Luminance”, while the Cb and Cr represent the color difference been separated from the “Luminance”. In both still and motion picture compression algorithms, the 8×8 pixels “Block” based Y, Cb and Cr goes through the similar compression procedure individually.

There are essentially three types of picture encoding in the MPEG video compression standard. I-frame, the “Intra-coded” picture uses the block of 8×8 pixels within the frame to code itself. P-frame, the “Predictive” frame uses previous I-type or P-type frame as a reference to code the difference. B-frame, the “Bi-directional” interpolated frame uses previous I-frame or P-frame as well as the next I-frame or P-frame as references to code the pixel information. In principle, in the I-frame encoding, all “Block” with 8×8 pixels go through the same compression procedure that is similar to JPEG, the still image compression algorithm including the DCT, quantization and a VLC, the variable length encoding. While, the P-frame and B-frame have to code the difference between a target frame and the reference frames.

In compressing or decompressing the P-type or B-type of video frame or block of pixels, the referencing memory dominates high semiconductor die area and cost. If the referencing frame is stored in an off-chip memory, due to I/O data pad limitation of most semiconductor memories, accessing the memory and transferring the pixels stored in the memory becomes bottleneck of most implementations. One prior method overcoming the I/O bandwidth problem is to use multiple chips of memory to store the referencing frame which cost linearly goes higher with the amount of memory chip. Some times, higher speed clock rate of data transfer solves the bottleneck of the I/O bandwidth at the cost of higher since the memory with higher accessing speed charges more and more EMI problems in system board design.

The method and apparatus of this invention significantly speeds up the procedure of reconstructing the digital video frames of pixels without costing more memory chips or increasing the clock rate for accessing the memory chip.

### SUMMARY OF THE INVENTION

The present invention is related to a method of digital video compression and decompression with the referencing frame buffer compression and decompression which reduces the semiconductor die area/cost sharply since the referencing frame buffer dominate he die area in an SoC design. The present invention reduces semiconductor die area compared to its counterparts in the field of video stream compression and decompression and reaches good image quality.

The present invention of this efficient video bit stream compression and decompression reduce the data rate of the digital video frame which are used as reference for other non-intra type blocks of image in motion estimation and motion compensation.

According to one embodiment of the present invention, each block of Y, luminance and U/V, chrominance of the referencing frame are compressed and decompressed separately.

According to one embodiment of the present invention, variable bit rate of each block of the Y and U/V components is reached for the pixels within a referencing image frame and come out of a fixed bit rate of a whole referencing frame.

According to one embodiment of the present invention, a predetermined time is set to reconstruct a macro-block of Y and pixel components for motion estimation in video compression and for motion compensation in video decompression.

According to one embodiment of the present invention, a pixel buffer is designed to temporarily store a predetermined amount of compressed macro-blocks of Y and Cr/Cb pixel components for motion estimation in video compression and for motion compensation in video decompression.

It is to be understood that both the foregoing general description and the following detailed description are by examples, and are intended to provide further explanation of the invention as claimed.

### BRIEF DESCRIPTION OF THE DRAWINGS

FIG. 1 shows the basic three types of motion video coding.

FIG. 2 depicts a block diagram of a video compression procedure with two referencing frames saved in so named referencing frame buffer.

FIG. 3 illustrates the mechanism of motion estimation.

FIG. 4 illustrates a block diagram of a prior art video decoding.

FIG. 5 depicts this invention of video encoder SoC with on-chip reference memory and frame buffer compression codec and buffer.

FIG. 6 depicts this invention of a video decoder SoC with on-chip reference memory and frame buffer compression codec and buffer.

FIG. 7 depicts a video encoder SoC with off-chip reference memory and on-chip frame buffer compression codec and buffer.

FIG. 8 depicts a video decoder SoC with off-chip reference memory and on-chip frame buffer compression codec and buffer.

FIG. 9 depicts a mechanism of how to reconstruct a macro-block of pixels or searching range pixels.

### DESCRIPTION OF THE PREFERRED EMBODIMENTS

There are essentially three types of picture coding in the MPEG video compression standard as shown in FIG. 1. I-frame 11, the “Intra-coded” picture, uses the block of pixels within the frame to code itself. P-frame 12, the “Predictive” frame, uses previous I-frame or P-frame as a reference to code the differences between frames. B-frame 13, the “Bi-directional” interpolated frame, uses previous I-frame or P-frame 12 as well as the next I-frame or P-frame 14 as references to code the pixel information.

In most applications, since the I-frame does not use any other frame as reference and hence no need of the motion estimation, the image quality is the best of the three types of pictures, and requires least computing power in encoding since no need for motion estimation. The encoding procedure of the I-frame is similar to that of the JPEG picture. Because of the motion estimation needs to be done in referring both previous and/or next frames, encoding B-type frame consumes most computing power compared to I-frame and P-frame. The lower bit rate of B-frame compared to P-frame and I-frame is contributed by the factors including: the averaging block displacement of a B-frame to either previous or next frame is less than that of the P-frame and the quantization step is larger than that in a P-frame. In most video compression standard including MPEG, a B-type frame is not allowed for reference by other frame of picture, so, error in B-frame will not be propagated to other frames and allowing bigger error in B-frame is more common than in P-frame or I-frame. Encoding of the three MPEG pictures becomes tradeoff among performance, bit rate and image quality, the resulting ranking of the three factors of the three types of picture encoding are shown as below:

| | Performance | | |
|---|---|---|---|
| | (Encoding speed) | Bit rate | Image quality |
| I-frame | Fastest | Highest | Best |
| P-frame | Middle | Middle | Middle |
| B-frame | Slowest | Lowest | Worst |

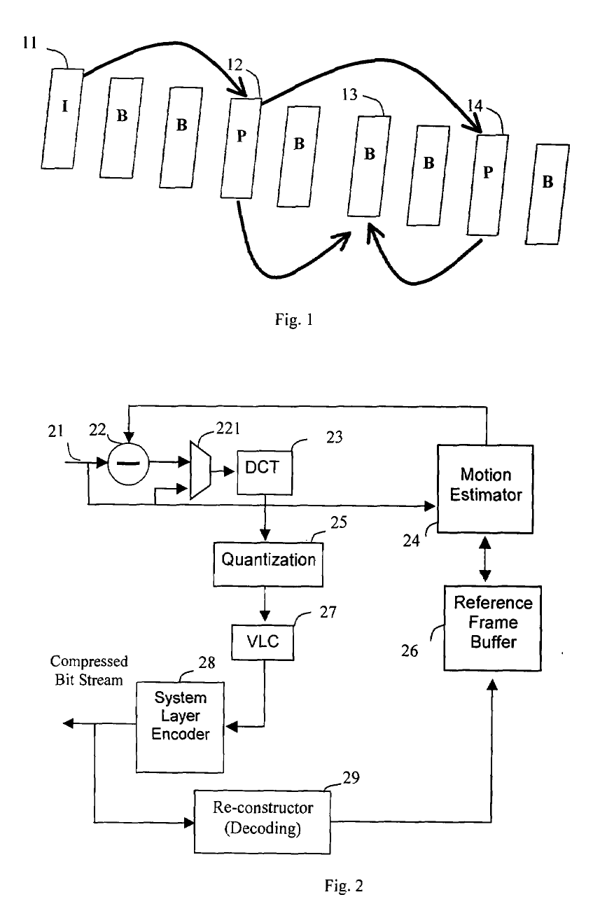

FIG. 2 shows the block diagram of the MPEG video compression procedure, which is most commonly adopted by video compression IC and system suppliers. In I-type frame coding, the MUX 221 selects the coming original pixels 21 to directly go to the DCT 23 block, the Discrete Cosine Transform before the Quantization 25 step. The quantized DCT coefficients are packed as pairs of “Run-Length” code, which has patterns that will later be counted and be assigned code with variable length by the VLC encoder 27. The Variable Length Coding depends on the pattern occurrence. The compressed I-type frame or P-type bit stream will then be reconstructed by the reverse route of decompression procedure 29 and be stored in a reference frame buffer 26 as future frames' reference. In the case of compressing a P-frame, B-frame or a P-type, or a B-type macro block, the macro block pixels are sent to the motion estimator 24 to compare with pixels within macroblock of previous frame for the searching of the best match macroblock. The Predictor 22 calculates the pixel differences between the targeted 8×8 block and the block within the best match macroblock of previous frame or next frame. The block difference is then fed into the DCT 23, quantization 25, and VLC 27 coding, which is the same procedure like the I-frame coding.

In the encoding of the differences between frames, the first step is to find the difference of the targeted frame, followed by the coding of the difference. For some considerations including accuracy, performance, and coding efficiency, in some video compression standards, a frame is partitioned into macroblocks of 16×16 pixels to estimate the block difference and the block movement. Each macroblock within a frame has to find the “best match” macroblock in the previous frame or in the next frame. The mechanism of identifying the best match macroblock is called “Motion Estimation”.

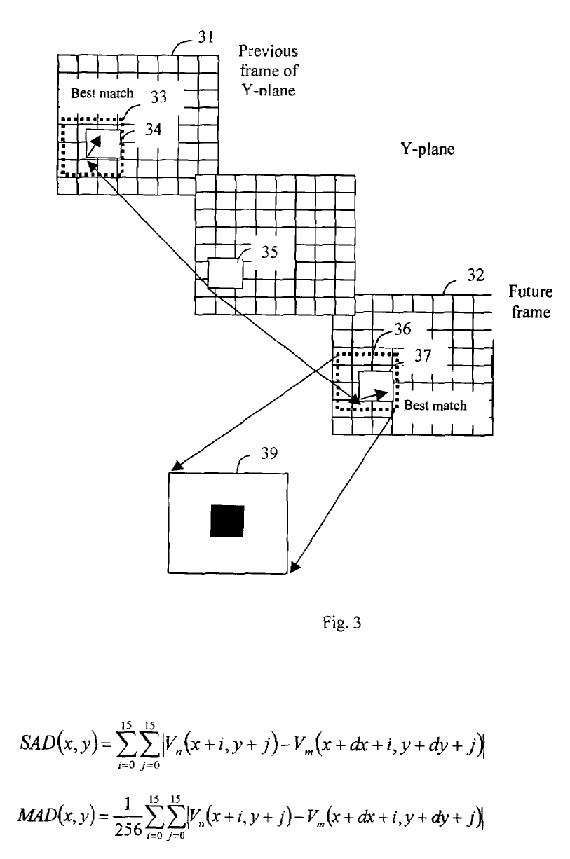

Practically, a block of pixels will not move too far away from the original position in a previous frame, therefore, searching for the best match block within an unlimited range of region is very time consuming and unnecessary. A limited searching range is commonly defined to limit the computing times in the “best match” block searching. The computing power hungered motion estimation is adopted to search for the “Best Match” candidates within a searching range for each macro block as described in FIG. 3. According to the MPEG standard, a “macro block” is composed of four 8×8 “blocks” of “Luma (Y)” and one, two, or four “Chroma (2 Cb and 2 Cr)”. Since Luma and Chroma are closely associated, in the motion estimation, only Luma mostion estimation is needed, and the Chroma, Cb and Cr in the corresponding position copy the same MV of Luma. The Motion Vector, MV, represents the direction and displacement of the block movement. For example, an MV=(5, −3) stands for the block movement of 5 pixels right in X-axis and 3 pixels down in the Y-axis. Motion estimator searches for the best match macroblock within a predetermined searching range 33, 36. By comparing the mean absolute differences, MAD or sum of absolute differences, SAD, the macroblock with the least MAD or SAD is identified as the “best match” macroblock. Once the best match blocks are identified, the MV between the targeted block 35 and the best match blocks 34, 37 can be calculated and the differences between each block within a macro block are encoded accordingly. This kind of block difference coding technique is called “Motion Compensation”.

The Best Match Algorithm, BMA, is the most commonly used motion estimation algorithm in the popular video compression standards like MPEG and H.26x. In most video compression systems, motion estimation consumes high computing power ranging from ˜50% to ˜80% of the total computing power for the video compression. In the search for the best match macroblock, a searching range, for example ±16 pixels in both X- and Y-axis, is most commonly defined. The mean absolute difference, MAD or sum of absolute difference, SAD as shown below, is calculated for each position of a macroblock within the predetermined searching range, for example, a ±16 pixels of the X-axis

$$SAD ( x , y ) = {\sum }_{i = 0}^{15} {\sum }_{j = 0}^{15} \vert {V}_{n} ( x + i , y + j ) - {V}_{m} ( x + dx + i , y + dy + j ) \vert$$

$$MAD ( x , y ) = \frac{1}{256} {\sum }_{i = 0}^{15} {\sum }_{j = 0}^{15} \vert {V}_{n} ( x + i , y + j ) - {V}_{m} ( x + dx + i , y + dy + j ) \vert$$

and Y-axis. In above MAD and SAD equations, the Vn and Vm stand for the 16×16 pixel array, i and j stand for the 16 pixels of the X-axis and Y-axis separately, while the dx and dy are the change of position of the macroblock. The macroblock with the least MAD (or SAD) is from the BMA definition named the “Best match” macroblock. The calculation of the motion estimation consumes most computing power in most video compression systems.

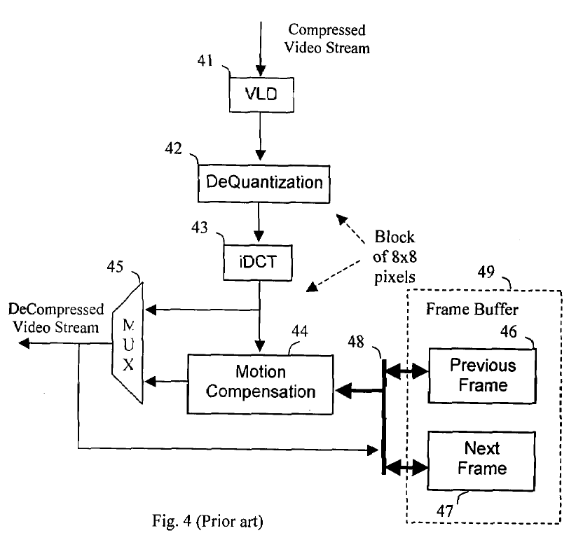

FIG. 4 illustrates the procedure of a prior art MPEG video decompression. The compressed video stream with system header having many system level information including resolution, frame rate, . . . etc. is decoded by the system decoder and sent to the VLD 41, the variable length decoder. The decoded block of DCT coefficients is shifted by the “Dequantization” 42 before they go through the iDCT 43, inverse DCT, and recovers time domain pixel information. In decoding the non intra-frame, including P-type and B-type frames, the output of the iDCT are the pixel difference between the current frame and the referencing frame and should go through motion compensation 44 to recover to be the original pixels. The decoded I-frame or P-frame can be temporarily saved in the frame buffer 49 comprising the previous frame 46 and the next frame 47 to be reference of the next P-type or B-type frame. When decompressing the next P-type frame or next B-type frame, the memory controller will access the frame buffer and transfer some blocks of pixels of previous frame and/or next frame to the current frame for motion compensation. Storing the referencing frame buffer on-chip costs high semiconductor die area and very costly. Transferring block pixels to and from the frame buffer consumes a lot of time and I/O bandwidth of the memory or other storage device. To reduce the required density of the temporary storage device and to speed up the accessing time in both video compression and decompression, compressing the referencing frame image is an efficient new option.

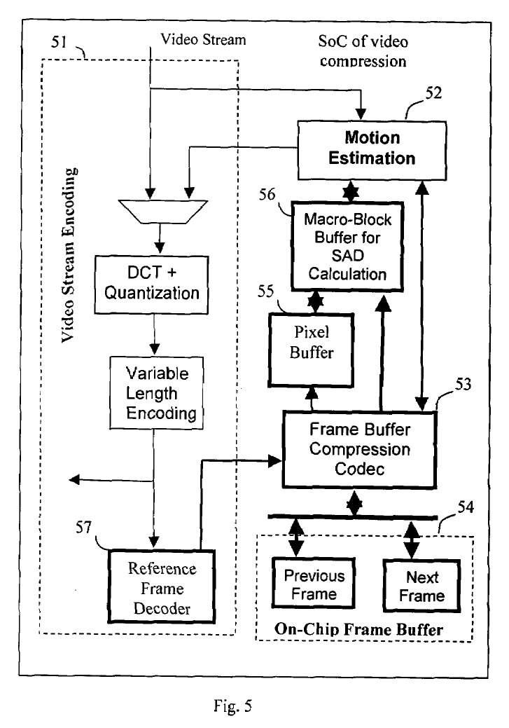

FIG. 5 shows this invention of the video compression mechanism with the on-chip referencing frame buffer and a frame buffer compression/decompression engine. The basic video compression procedure 51 includes a DCT engine, quantization circuit, a VLC encoder and the final data packer. In the mode of non-intra coding, the coming picture are compared to previous and/or next frame for coding the difference which is called “motion estimation” 52. The compressed I-type or P-type frame will be reconstructed 57 to be used as referencing frame for future P-type or B-type frame coding through the motion estimation and differential value coding. In present invention, the reference block pixels of previous frame and/or the next frame are compressed 53 block by block before saving into the on-chip frame buffer 54. To reach best image quality under a targeted compression rate, each block of pixels are compressed with variable bit rate and comes out of a fixed bit rate of a whole frame. Since the motion estimation is macro-block based, the referencing frame buffer compression codec 53 reads the compressed frame pixels and put to a temporary pixels buffer 55 with the amount no less than a macro-block of pixels and to fill in a macro-block buffer 56 for the SAD calculation. The motion estimation requires hundreds of clock numbers to calculate the SAD, Sum of Absolute Difference, in the mea time, the referencing frame buffer compression codec gets information from the motion estimation engine and decides which range of area is needed to be reconstructed for the next SAD calculation. Therefore, some pixels in the temporary pixel buffer 55 will be re-used again. Within the video compression engine, there is a timing scheduler which instructs the referencing frame buffer compression codec when to reconstruct the macro-block of pixels for motion estimation which.

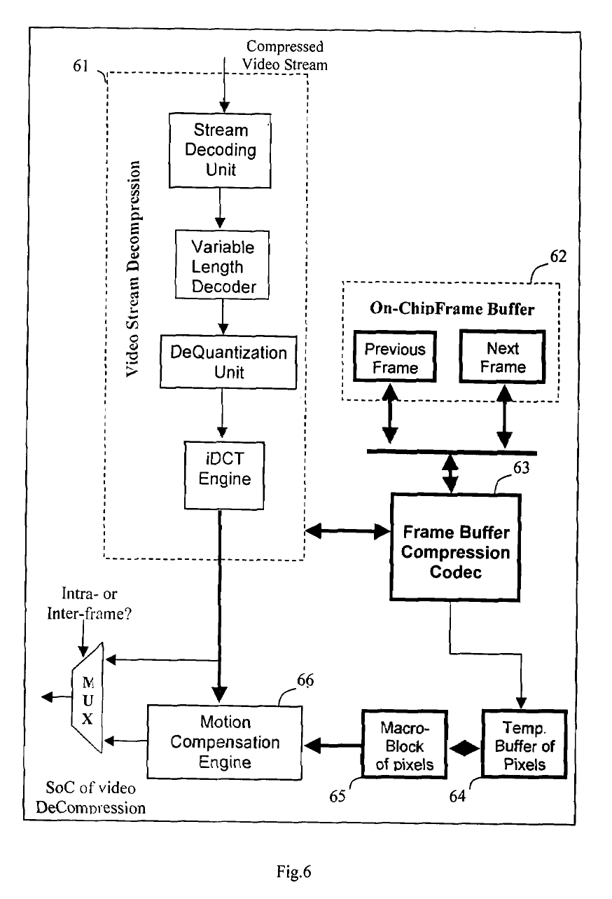

While, FIG. 6 shows this invention of the video decompression mechanism with the on-chip referencing frame buffers 62 and the referencing frame compression codec 63. The basic video decompression procedure 61 includes a video stream decoding unit, a VLC decoding unit, a de-quantization, and an inverse DCT. In the mode of non-intra decoding, the reconstructed reference block pixels of previous frame and/or the next frame are compressed again block by block with variable data rate of each block before saving into the referencing frame buffer 62 which sharply reduces the required density of the storage device to save the referencing frame pixels. Although the referencing frame is compressed block by block with variable bit rate, it comes out of a fixed bit rate of a whole frame to fit into the targeted storage device density.

During motion compensation which is a macro-block based mechanism, the referencing frame buffer compression codec 63 reads the compressed frame pixels, decompresses and puts to a temporary pixels buffer 64 with the amount no less than a macro-block of pixels and to fill in a macro-block buffer 65 for the calculation of motion compensation 66. The referencing frame buffer compression codec gets information from the video decoding engine and decides which range of area is needed to be reconstructed for the next motion compensation calculation. Therefore, some pixels in the temporary pixel buffer 65 will be re-used again.

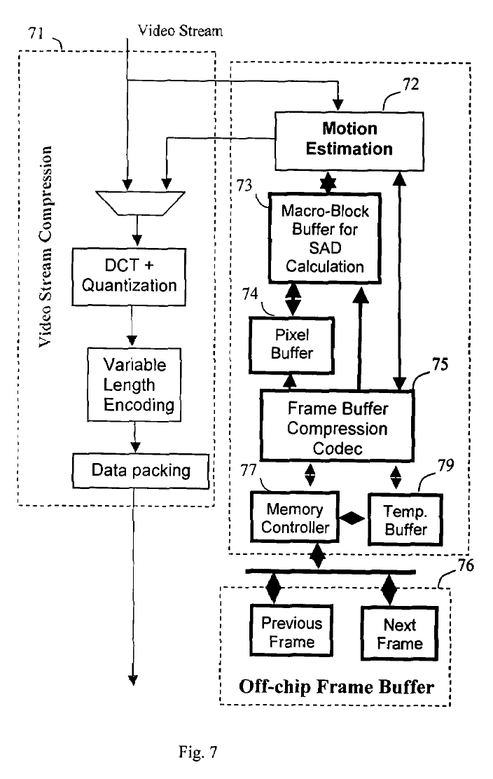

For saving the semiconductor die area and cost, the compressed referencing frame pixel information with variable bit rate each block in the video compression or decompression can be saved into the off-chip memory buffer 76. When compressing video stream, the memory controller 77 accesses the compressed referencing frame data in a pipelining mechanism and stores into a temporary buffer 79 before sending to the decompression engine 75 to reconstruct the pixels before storing in a temporary pixel buffer 74 as shown in FIG. 7. The reconstructed pixels are organized as macro-block for the SAD calculation 73 of the motion estimation 72.

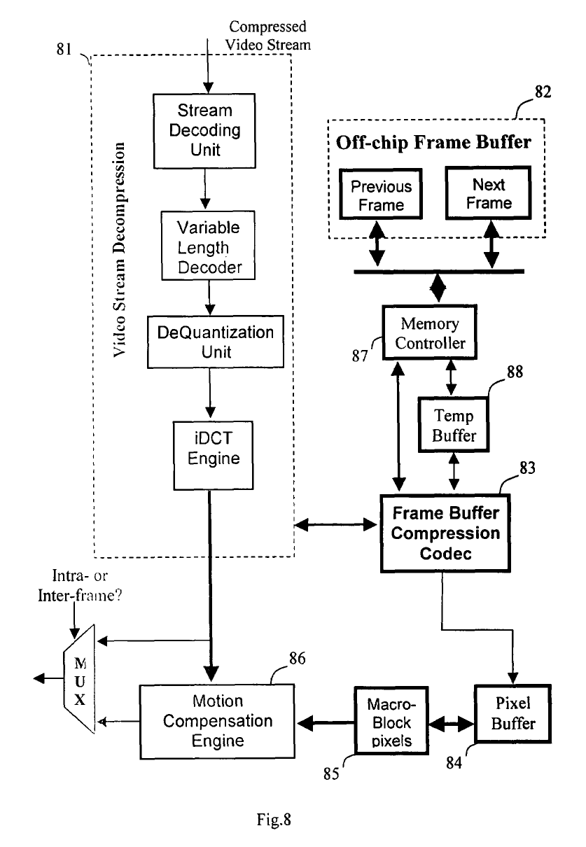

Similar to the video encoding depicted above, as shown in FIG. 8, in decompressing the video frames, the compressed referencing frame 83 of pixels can be stored into an off-chip memory buffer 82. During motion compensation, the memory controller 87 accesses the off-chip frame buffer 82 and saves into a temporary image buffer 88 before sending to the referencing frame buffer decompression engine 83 to decode the needed area of pixels and temporarily stores them into a pixel buffer 84 and to reconstruct the macro-block 85 of pixels for motion compensation 86.

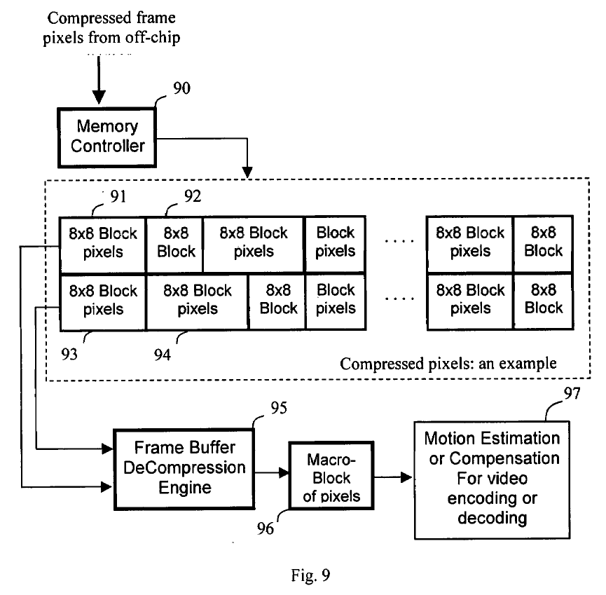

FIG. 9 illustrates more details of accessing the off-chip memory storing the compressed and storing to a temporary pixel buffer before reconstructing macro-block by macro-block pixels. This approach applies to video compression and the video decompression as well. The compressed referencing frame pixels are stored in the off-chip memory buffer with some code identifying the address of beginning of each new 8 lines of 8×8 (or 16×16) blocks. Then, the memory controller 90 can access each 8×8 (or 16×16) blocks of two 8 or 16 lines at a time and stores into a temporary pixel buffer. Since the 8×8 or 16×16 block pixels are compressed with variable bit rate, the data amount of each block is ranges from block to block 91, 92, 93, 94. For example, the two 8×8 blocks of upper 8 lines and another two 8×8 blocks of lower 8 lines of compressed pixels can be decompressed 95 and reconstruct into a macro-block of 16×16 pixels by following the instruction decoded from the motion vector embedded in the video stream. Both video encoder and video decoder requires larger searching range, hence about four lines 8×8 or 16×16 lines (for example, a total of 32 lines) are needed for quickly reconstruct the macro-block 96 for the motion compensation in video decoder and an entire searching range of pixels for the video encoder 97. For further reducing the temporary line buffer, after reconstructing macro-block by macro-block pixels, those upper 16×16 blocks no longer needed can be overwritten by the newly accessed lower 16×16 macro-block pixel data.

There are several configurable register bits, CREG[0:3], which can be programmed to instruct the referencing frame compression codec the targeted compression rate, or said, bit rate per frame and the codec functions accordingly. For example: CREG[0:3]=1.0 compression rate, CREG[0:3]=1.5 compression rate, CREG[0:3]=1.8 compression rate, CREG[0:3]=2.0 compression rate, CREG[0:3]=2.4 compression rate, CREG[0:3]=2.7 compression rate, CREG[0:3]=3.0 compression rate, CREG[0:3]=4.0 compression rate. . . . etc.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. An apparatus of digital video compression or digital video decompression with an on-chip referencing frame buffer, comprising:
in digital video compression: the apparatus is comprised of
a video stream encoding unit which includes DCT unit, quantization unit and VLC coding unit and referencing frame reconstruction unit;
A motion estimator which calculates and determines the best matching macro-block of at least one neighboring frame;
A referencing frame compression and decompression unit which compresses the reconstructed referencing frame block by block with variable bit rate before storing to the frame buffer and decompressed the pixels of the corresponding searching range;
A storage device saving the compressed referencing frame pixels;
A temporary image buffer which stores the decompressed pixels of at least one macro-block of pixels; and
A macro-block pixel buffer for storing the pixels of a macro-block prepared for the nearest SAD calculation;
in digital video decompression: the apparatus is comprised of
a video stream decoding unit which includes iDCT unit, DeQuantization unti and VLD coding unit;
A motion compensation unit which adds the decompressed differential values of block pixels from the video stream to the corresponding block pixels of referencing frame;
A referencing frame image compression and decompression unit which compresses the decompresses referencing frame with variable bit rate from block to block before storing to the frame buffer and decompresses pixels of the corresponding searching range;
A storage device saving the compressed referencing frame pixels;
A temporary image buffer which stores the decompressed pixels of at least one macro-block of pixels; and
A macro-block pixel buffer for storing the pixels of a macro-block prepared for the motion compensation calculation.

2. The apparatus of claim 1, wherein the referencing frame compression codec reduces the bit number of each block pixels of the decompressed I-type or P-type referencing frame to be variable length from block to block before saving to the on-chip storage device.

3. The apparatus of claim 1, wherein the pixel number of each block of the decompressed I-type or P-type referencing frame image is fixed.

4. The apparatus of claim 3, wherein the block is comprised of 2×2, 4×4 pixels or 8×8 pixel or 16×16 pixels in vide decoding, and 8×8 pixel or 16×16 pixels or 32×32 or 64×64 pixels in video encoding.

5. The apparatus of claim 1, wherein each starting address of the left edge block of pixels of the compressed referencing frame image is stored in a location of bit stream and hence saved in the on-chip storage device, when reading back the compressed referencing frame, this address is accessed and the corresponding block pixels is read and reconstructed accordingly.

6. The apparatus of claim 1, wherein the temporary pixel buffer which stores the reconstructed blocks of pixels is comprised of at least one block of Y, luminance and Cr/Cb chrominance components for motion compensation in vide decoding, and stores a predetermined searching range of pixels for motion estimation in video encoding.

7. The apparatus of claim 1, a sequential controller determines the timing to start accessing and decompressing the compressed referencing frame image and to organize the reconstructed macro-block pixels to be the shape which fits the area requirements in video encoding and in video decoding.

8. An apparatus of digital video compression or digital video decompression with an off-chip referencing frame buffer, comprising:
in digital video compression: the apparatus is comprised of
a video stream encoding unit which includes DCT unit, quantization unit and VLC coding unit and a referencing frame reconstruction unit;
a motion estimator which calculates and determines the best matching macro-block of at least one neighboring frame;
a referencing frame compression and decompression unit which compresses the reconstructed referencing frame with variable bit rate from block to block before storing to the frame buffer and decompresses the pixels of the corresponding searching range;
the first temporary image buffer which stores the compressed referencing frame pixels of at least one macro-block pixels accessed from the memory controller;
the second temporary image buffer which stores at least one decompressed referencing frame macro-block pixels from the referencing frame compression codec;
a macro-block pixel buffer for storing the pixels of a macro-block prepared for the nearest SAD calculation; and
an off-chip storage device saving the compressed referencing frame pixels;
in digital video decompression: the apparatus is comprised of
a video stream decoding unit which includes iDCT unit, DeQuantization unti and VLD coding unit and referencing frame reconstruction unit;
A motion compensation unit which add the decompressed differential value of blocks of pixel to the corresponding block pixels of referencing frame;
A referencing frame compression and decompression unit which compresses the decompressed referencing frame block by block with variable bit rate before storing to the frame buffer and decompressed the pixels of the corresponding searching range;
the first temporary image buffer which stores the compressed referencing frame pixels of at least one macro-block pixels accessed from the memory controller;
the second temporary image buffer which stores at least one decompressed referencing frame macro-block pixels from the referencing frame compression codec;
A macro-block pixel buffer for storing the pixels of a macro-block prepared for the motion compensation calculation; and
An off-chip storage device used to save the compressed referencing frame pixels.

9. The apparatus of claim 8, wherein a predetermined size of output buffer temporarily saves the compressed referencing frame data and writes into the off-chip storage device before the output buffer is full.

10. The apparatus of claim 8, wherein before the video encoder starts motion estimation or the video decoder starts the motion compensation, the compressed referencing frame data are accessed by a memory control unit and temporarily saved to a pixel buffer before sending to the on-chip referencing frame image decompression unit for recovering.

11. The apparatus of claim 8, wherein the motion vector of compressed video stream decides which block of pixels needed to be recovered and the referencing compression codec decompresses the accessed compressed reference frame image accordingly.

12. The apparatus of claim 8, wherein the motion estimator of video compression decides which searching range of pixels needed to be recovered and the referencing compression codec decompresses the accessed compressed reference frame image accordingly.

13. The apparatus of claim 8, wherein the referencing frame is compressed block by block with variable bit rate and comes out of a whole frame bit rate under a predetermined fixed bit rate.

14. The apparatus of claim 8, wherein the referencing frame compression codec functions according to the final compression ratio of the referencing frame is instructed by an embedded register and the final referencing frame bit rate is reduced.

15. A method of reconstructing blocks of pixels of the referencing frame buffer for motion estimation in video encoding and for motion compensation in video decoding, comprising:
accessing the compressed referencing frame pixels with corresponding location of starting block which are embedded in the compressed referencing frame stream;
temporarily storing the accessed compressed pixels into a pixel buffer;
sequentially decompressing the corresponding blocks of pixels and organizing them as macron-block of pixels for motion compensation in video decompression and as searching range pixels for motion estimation in video compression; and
overwriting at least two upper lines of temporary buffer which stores the compressed pixel with new coming compressed referencing frame pixels.

16. The method of claim 15, wherein the temporary pixel buffer is comprised of storage device which can store at least 4 lines of compressed referencing frame image and can be overwritten when upper lines buffer are no long needed.

17. The method of claim 15, wherein at least 4 upper lines of the temporary pixel buffer can be overwritten by newly accessed compression block pixels when these upper lines are no long needed.

18. The method of claim 15, wherein the decoded motion vector of the compressed video stream instructs the referencing frame compression codec how and where to start decompressing the accessed referencing frame pixels and to recover the needed macro-block to be used in the motion compensation.

19. The method of claim 15, wherein at least two continuous blocks of the compressed Y luminance components are saved in to the storage device with continuous location and at least two continuous blocks of UN chrominance components are saved to the storage device with another continuous location.

20. The method of claim 15, wherein the motion estimator of the video encoder instructs the referencing frame compression codec how and where to start decompressing the accessed referencing frame pixels and to recover the needed searching range pixels to be used in the SAD calculation and identifying the best match macro-block.
